(19) United States
(12) Patent Application Publication
(10) Pub. No.: US 2017/0323587 A1
(43) Pub. Date: Nov. 9, 2017

(54) BLOOD-VESSEL-SHAPE CONSTRUCTION DEVICE FOR BLOOD-FLOW SIMULATION, METHOD THEREFOR, AND COMPUTER SOFTWARE PROGRAM

(71) Applicant: EBM CORPORATION, Tokyo (JP)

(72) Inventors: Takanobu YAGI, Tokyo (JP); Young-Kwang PARK, Tokyo (JP)

(21) Appl. No.: 15/503,623

(22) PCT Filed: Oct. 8, 2015
(86) PCT No.: PCT/JP2015/078695

§ 371 Date: Jul. 24, 2017

Related U.S. Application Data
(60) Provisional application No. 62/061,440, filed on Oct. 8, 2014.

(51) Int. Cl. G09B 23/30; G06T 7/90; G06T 7/00; G06T 7/11

(52) U.S. Cl. CPC G09B 23/303; G09B 23/30; G06T 7/0012; G06T 7/90; G06T 7/11; G06T 2207/30104

(57) ABSTRACT

This device for constructing a blood-vessel-shape model in order to perform blood-flow analysis using computational fluid dynamics is provided with: an input unit which inputs a medical image; a shape-model generation unit which constructs, based on the medical image, a blood-vessel-shape model; a shape-model-quality evaluation unit which evaluates the shape reproduction degree of the constructed blood-vessel-shape model to determine the quality of the blood-vessel-shape model; and an output unit which outputs the determination result and the constructed blood-vessel-shape model.

### BACKGROUND OF THE INVENTION

### Field of the Invention

The present invention relates to a blood-vessel-shape construction device, a method therefor and a computer software program.

Cardiovascular diseases include vascular aneurysm, sclerosis and stenosis. These diseases are caused by lesions of normal regions influenced by blood flow and frequently lead to death due to subsequent progress, but it is extremely difficult to treat these diseases because life might be endangered. Blood-flow analysis using computational fluid dynamics (CFD) is useful in determining diagnoses and therapeutic methods for those intractable cardiovascular diseases or understanding the causes of onset and progress thereof.

The computational fluid dynamic is a technology used for understanding fluid flow based on computational analysis using a computer. By way of example, Japanese Patent No. 5596866 discloses a technology for constructing a three-dimensional blood-vessel-shape model from medical image data obtained by performing imaging using a medical imaging device or the like in order to simulate blood-vessel treatment effects and, based on the blood-vessel shape model, performing blood-flow analysis using computational fluid dynamics.

However, the abovementioned blood-flow analysis based on a blood-vessel-shape model has the problem that the precision of analytical results is significantly influenced by the precision of constructing a blood vessel shape. By way of example, medical image data used for constructing a blood-vessel-shape model varies in its nature depending on the type of imaging devices, manufacturers, imaging conditions, etc., which leads to variations in the results of blood-flow analysis. Furthermore, conventional methods for constructing blood vessel shapes depend on users, because users decide the selection of input images, the determination and extraction of blood vessel regions and lesions and the setting of various parameters. Furthermore, a blood vessel associated with a lesion has lesion specifics such as peripheral blood vessels that cannot be included in blood-flow analysis, vascular adhesions, stenosis, aneurysms and the like. Accordingly, in conventional construction methods, a blood-vessel shape having each of those lesion specifics must be specified and extracted one by one, which causes a tremendous amount of cost and labor in addition to the user dependency.

In order to make blood-vessel analysis using computational fluid dynamics available widely, it is important to standardize and share the evaluation of shape model construction, thereby providing a shape model with high precision and reliability. However, the quality of a vascular-vessel-shape model inputted for blood-flow analysis has hardly been evaluated, nor its precision assured enough.

### SUMMARY OF THE INVENTION

The present invention was made in view of the abovementioned circumstances, and the purpose of the present invention is to provide a blood-vessel-shape construction device that makes it possible to control the quality of constructing a blood vessel shape for the purposes of blood flow simulation, a method therefor and a computer software program.

According to a first major point of this invention, provided is a device for constructing a blood-vessel-shape model in order to perform blood-flow analysis using computational fluid dynamics, the device comprising: an input unit which inputs a medical image; a shape-model generation unit which constructs, based on the medical image, a blood-vessel-shape model; a shape-model-quality evaluation unit which evaluates shape reproduction degree of the constructed blood-vessel-shape model to determine the quality of the blood-vessel-shape model; and an output unit which outputs the determination result and the constructed blood-vessel-shape model.

In one embodiment of this invention, the medical image comprises luminance information; the shape-model-quality evaluation unit, using the luminance information about the medical image, calculates a luminance gradient in the direction perpendicular to a blood vessel wall in the vicinity of the blood vessel wall of the constructed blood-vessel-shape model to determine the quality of the shape model based on the luminance gradient; and when the luminance gradient of the blood-vessel-shape model has a lower region than a prescribed value, the shape-model-quality evaluation unit determines it as low quality. In this case, the output unit preferably further outputs and displays the region of low quality on the constructed blood-vessel-shape model. Furthermore, the shape-model-quality evaluation unit preferably calculates a luminance gradient for each unit region of the constructed blood-vessel-shape model to determine a place having a luminance gradient of a threshold level or lower as a place of low quality, calculates the ratio of the low-quality place to the entire surface of the shape model, and outputs a score based on the ratio of the low quality place as the determination result.

Furthermore, in another embodiment of this invention, the abovementioned device further provides an image quality determination unit which acquires the type information of the medical image to determine the quality of the medical image by checking this type information against a quality determination table. In this case, the image quality determination unit preferably rejects the image, thereby preventing the blood-vessel-shape model from being generated when the medical image does not satisfy prescribed quality. Furthermore, the quality determination table comprises at least one piece of information from among an imaging device, an imaging condition and a manufacturer.

In another embodiment, the abovementioned shape-model generation unit comprises: a first extraction unit which extracts a blood vessel region from the medical image and generates a blood vessel center line in at least one portion of the blood vessel region; and a second extraction unit which performs intervascular/extravascular determination for the blood vessel site in which the blood vessel center line has been generated based on the blood vessel center line and the medical image and also performs intervascular/extravascular determination for the blood vessel site in which no blood vessel center line has been generated based on the medical image, thereby forming a precise blood-vessel-shape model. In this case, the first extraction unit preferably calculates a center line candidate point group of the blood vessel and generates the blood vessel center line based on the center line candidate point group. Furthermore, in this case, the first extraction unit preferably calculates the density of the center line candidate point group and the segment length of the blood vessel center line to determine the size and shape of the blood vessel based on the density and the segment length. Furthermore, in this case, the second extraction unit preferably performs blood vessel structure analysis based on the blood vessel center line to generate a second precise blood vessel center line and blood vessel wall. Furthermore, the blood vessel structure analysis is preferably performed for a region within an orthogonal cross-section that passes through each point on the blood vessel center line generated at the first extraction unit.

According to a second major point of this invention, provided is a computer software program executed by a computer for constructing a blood-vessel-shape model in order to perform blood-flow analysis using computational fluid dynamics, the program comprising each of the following commands stored in a storage medium: an input unit at which a computer reads a medical image; a shape-model generation unit at which the computer constructs a blood-vessel-shape model based on the medical image; a shape-model-quality evaluation unit at which the computer evaluates the shape reproduction degree of the constructed blood-vessel-shape model to determine the quality of the blood-vessel-shape model; and an output unit at which the computer outputs the determination result and the constructed blood-vessel-shape model.

According to a third major point of this invention, provided is a method executed by a computer in order to construct a blood-vessel shape model for performing blood-flow analysis using computational fluid dynamics, the method comprising: a reading step for reading a medical image using a computer; a shape-model generation step for constructing a blood-vessel-shape model using a computer based on the medical image; a shape-model-quality evaluation step for evaluating the shape reproduction degree of the constructed blood-vessel-shape model using a computer in order to determine the quality of the blood-vessel-shape model; and an output step for outputting the determination result and the constructed blood-vessel-shape using a computer.

Each of the abovementioned configurations of this invention is provided with the function of evaluating the quality of inputted medical image data as well as evaluating the quality of a constructed blood-vessel-shape model and makes it possible to obtain a device that can construct a blood vessel shape of higher quality by properly processing an image and a shape model based on the those evaluations.

The characteristics of this invention other than those described above can readily be appreciated by those skilled in the art by making reference to “Detailed Description of the Invention” as shown below as well as drawings.

### BRIEF DESCRIPTION OF THE DRAWINGS

FIG. 1 is a view explaining computational fluid dynamics.

FIG. 2 is a flow diagram showing blood-flow analysis using computational fluid dynamics.

FIG. 3 is a flow diagram showing blood-vessel-shape construction.

FIG. 4 is a schematic block diagram showing one embodiment of this invention.

FIG. 5 is a flow diagram showing preprocessing.

FIG. 6 is a flow diagram showing the generation of a blood vessel model.

FIG. 7 is a view explaining processing at the coarse extraction unit.

FIG. 8 is a view explaining processing at the precise extraction unit.

FIG. 9 is a view explaining the quality determination of a blood-vessel-shape model.

FIG. 10 is a view showing an example of result display.

### DESCRIPTION OF THE EMBODIMENTS

A description of one embodiment of this invention is given below in detail based on drawings.

As described above, the present invention relates to a blood-vessel-shape construction device for performing blood-flow analysis using computational fluid dynamics (CFD), a method therefor and a computer software program and particularly to a device that evaluates the quality of inputted medical image data, has the function of evaluating the quality of a constructed blood-vessel-shape model and can construct a blood vessel shape of higher quality by properly processing an image and a shape model based on those evaluations.

In order to briefly explain this embodiment, the following first describes the concept of analysis performed using computational fluid dynamics. In the computational fluid dynamics, the flow of fluid is calculated by performing computational analysis using a computer and then outputted. In more detail, a governing equation describing flow (continuum equation, Navier-Stokes equation) is replaced with an algebraic equation and an approximate solution is obtained by sequential computation.

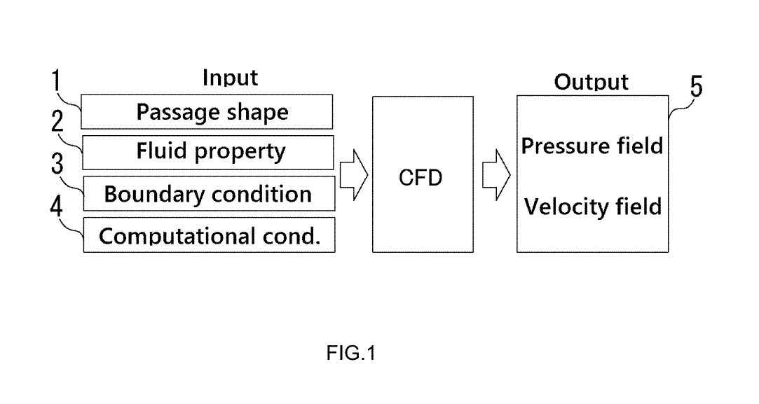

As shown in FIG. 1, there are four inputs in computational fluid dynamics, that is, flow passage shape 1, fluid property 2, boundary condition 3 and computational condition 4, and the output is pressure field/velocity field 5 in the space. The pressure field/velocity field 5 in the time and space can be calculated by solving the abovementioned governing equation as a time development type.

Here, the flow passage shape 1 is specifically designed by CAD (computer-aided-design) or the like on a computer. The fluid property 2 is specifically density and viscosity. The boundary condition 3 is specifically a velocity/pressure distribution at the edge face of each conduit and the condition of constraint at the wall face. By way of example, the velocity is set to zero by disregarding the velocity distribution at inlets and outlets and the slip of fluid at the wall face (non-slip condition). The computational condition 4 is to generate a computational mesh for a given flow passage shape and is the discretization of equations for equation solving and a solution of simultaneous equations.

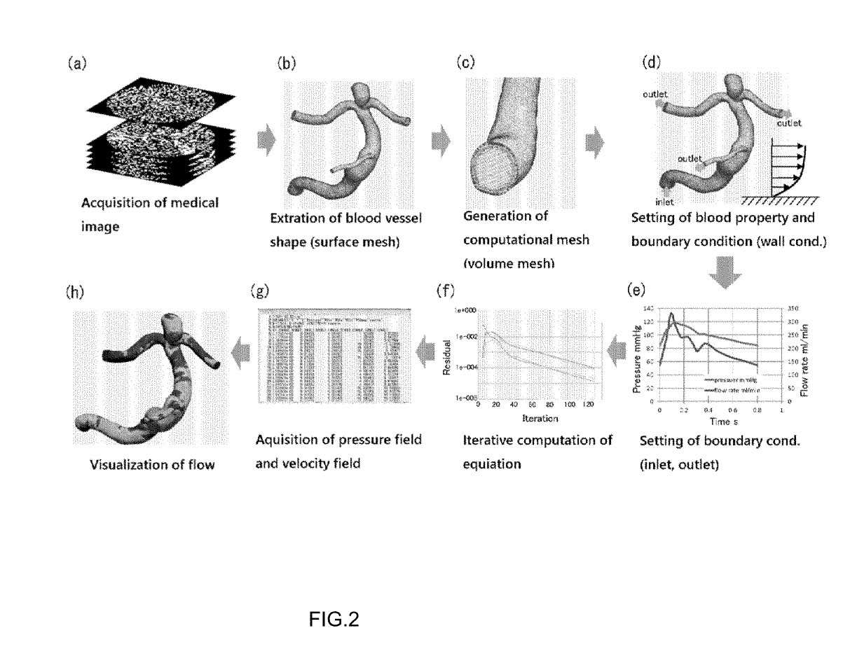

FIG. 2 is a flow diagram showing blood-flow analysis using the abovementioned computational fluid dynamics. Its detailed explanation is omitted here.

Next, the following describes the concept of constructing a blood vessel shape in this embodiment.

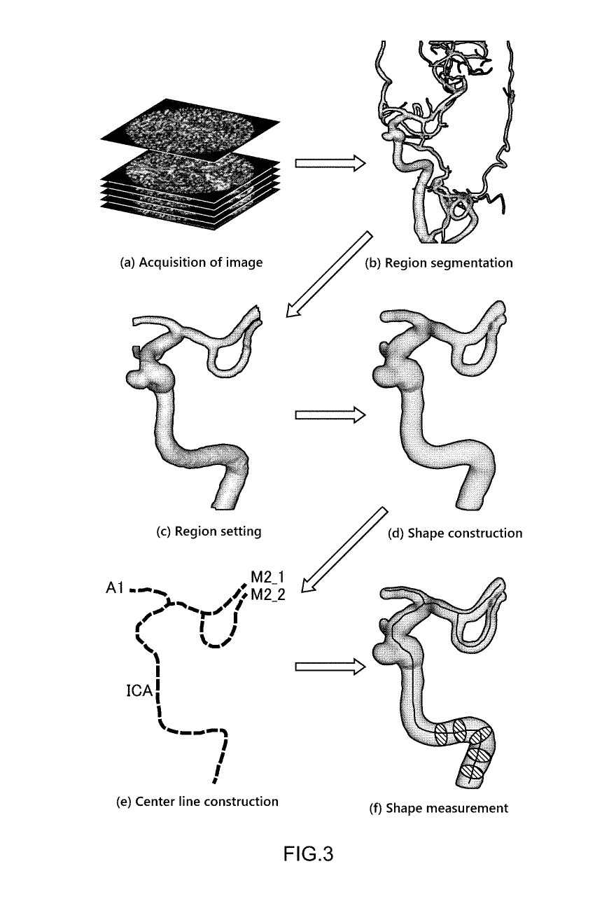

FIG. 3 shows the process of constructing a blood vessel shape. In the blood-vessel-shape construction, a medical image is first obtained (FIG. 3 (a)). Next, the intervascular/extravascular is determined based on the medical image and then region segmentation is performed (FIG. 3 (b)). Next, a region to be examined is set (FIG. 3 (c)). Next, a curved face is constructed using Marching cubes or the like (FIG. 3 (d)). As a result, the image is transferred to a polygon space from a voxel space. In other words, the blood vessel wall face is constructed of minute triangular elements at this point. Next, a center line is constructed for each blood vessel (FIG. 3 (e)). Subsequently, space measurement, etc. are performed (FIG. 3 (f)).

The precision of the blood vessel shape thus constructed have a direct influence on the result of the abovementioned blood-flow analysis. Accordingly, it is important to construct a blood vessel model with high precision and reliability. The blood-vessel-shape construction device in this embodiment is to construct a blood vessel model with high precision and reliability by carrying out the processing as shown below.

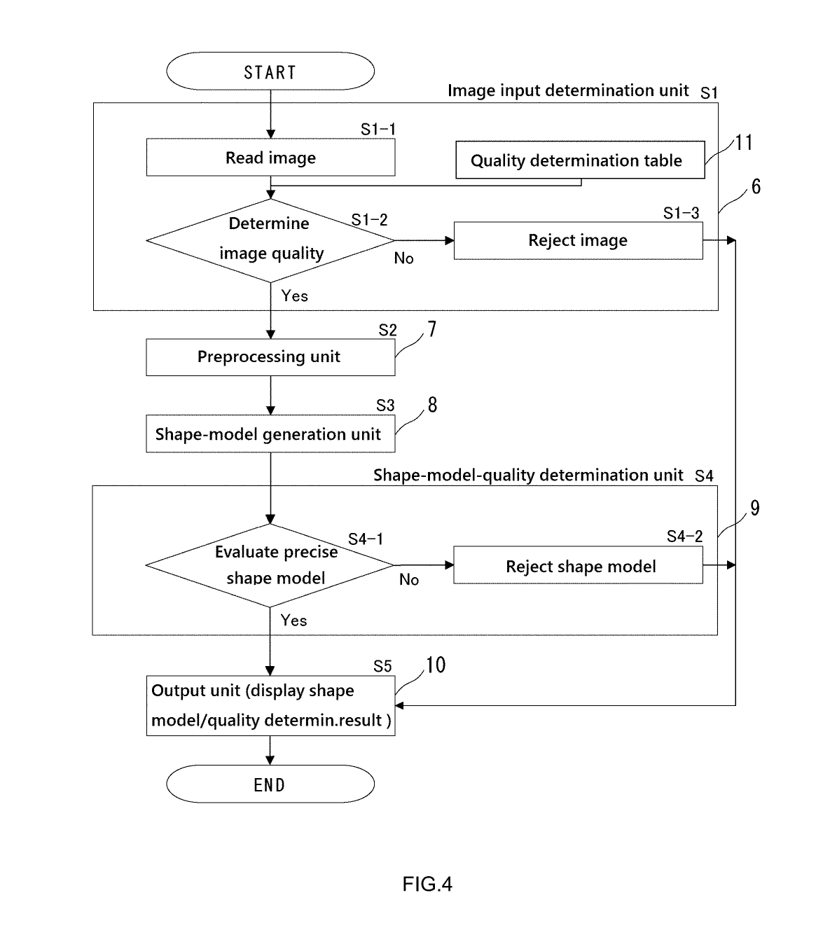

FIG. 4 is a schematic block diagram showing one embodiment of this invention. This device is largely comprised of an image input determination unit 6, a preprocessing unit 7, a shape-model generation unit 8, a shape-model-quality determination unit 9 and an output unit 10. The configuration is such that each of these component units 6-10 is actually a computer software program stored on a storage medium such as a hard disk and is developed on RAM by the CPU of a computer to be sequentially executed.

### Image Input Determination Unit (S1)

After reading a medical image for extracting a blood vessel (S1-1), the image input determination unit 6 determines the quality of the images based on a quality determination table 11 (S1-2), rejects those of poor quality (S1-3) and sends only those of good quality to the next step.

In this embodiment, medical images are those imaged by a medical imaging device. The medical imaging device includes IVUS (Intravascular Ultrasound) and OCT (Optical Coherence Tomography) in addition to mainstream devices at present such as MRA (Magnetic Resonance Angiography), CTA (Computed Tomography Angiography) and DSA (Digital Subtraction Angiography). Although many of recent medical images follow such a standard of image type as a DICOM standard, there is hardly any standard for evaluating the quality of images. Accordingly, there is so large a variation in the quality of medical images that the problem is that precision cannot be assured, nor is the result of high reliability achieved, if blood-flow simulation is performed using a blood vessel shape constructed from such medical images.

As a result of conducting experimental study to solve this problem, the present inventors found that three differences, that is, (1) a difference in the type of imaging devices, (2) a difference in imaging conditions and (3) a difference in manufacturers caused the variation in the quality of filmed medical images and had a significant influence on the precision of results of blood-flow analysis performed by using blood-flow shapes constructed from those images.

Next, the following explains the influence of those three factors on images in detail. (1) The imaging method varies depending on the type of imaging devices. By way of example, in DSA, a catheter is placed inside an artery and a contrast medium injected therethrough. In MRA, an image is normally obtained by making the movement of blood flow into a signal without using a contrast medium. Thus, the characteristics of images tend to vary depending on the type of devices, and such device dependence of images influences the precision of blood vessel extraction. Furthermore, there are differences in the characteristics of images depending on the type of devices as shown below. In DSA, artifacts originated from hard tissues such as bones and calcified tissues can be removed by using a subtraction technique between contrast-enhanced images and unenhanced images. Since CTA is normally under the influence of bones and calcified tissues, it is desirable to use a subtraction technique for constructing a blood vessel shape. In MRA, signal intensity depends on velocity, and therefore the blood vessel shape of an image might be distorted due to flow disturbance. (2) The imaging condition includes spatial resolution, temporal resolution and the injection speed and concentration of a contrast medium. (3) Even when the type of devices is the same, the quality of images such as the level of noises varies depending on manufactures.

After reading medical images for extracting a blood vessel (S1-1), therefore, the image input determination unit 6 determines image quality by checking the type information of the medical images against the abovementioned quality determination table 11 (S1-2) and rejects those of poor quality, thereby limiting medical images to be transmitted to the next step.

The following specifically explains the processing for determining the quality of images. First, a data table 11 (hereinafter referred to as the “quality determination table”) having information about an imaging device, an imaging condition and a manufacturer, which are suitable for blood-flow simulation, is stored in a memory in advance. At the time of reading medical images, information about the imaging device, imaging condition and manufactures of those images is obtained from medical image data (S1-1) and it is determined whether or not the information corresponds to the information from the quality determination table 11 (S1-2). In the event that a read medical image does not correspond to the information from the quality determination table 11, the image is rejected, so that it cannot be inputted into the preprocessing unit 7 as explained below in detail. The determination result may be outputted from an output unit 10. By way of example, when an image is determined as poor quality and rejected, a message to that effect may be outputted to inform a user thereof. Alternatively, even when it is determined that a read medical image does not correspond to the information from the abovementioned data table, a message indicating the evaluation of low quality may be outputted, so that a user can confirm it, instead of automatically deleting the image. Thus, the variation of quality of blood vessel shapes to be constructed can be reduced by limiting medical images to be examined at the image determination unit 6.

### Preprocessing Unit (S2)

Although the image input determination unit 6 performs reading after setting a fixed limitation to medical images as described above, there is a certain variation in quality among images that are read within the limitation. This is because it is, in principle, impossible to make the same image due to different imaging principles among imaging devices such as DSA, CTA and MRA. Therefore, the preprocessing unit 7 performs correction processing for reducing the imaging device dependence, imaging condition dependence and manufacturer dependence of medical images that are read at the image input determination unit 6.

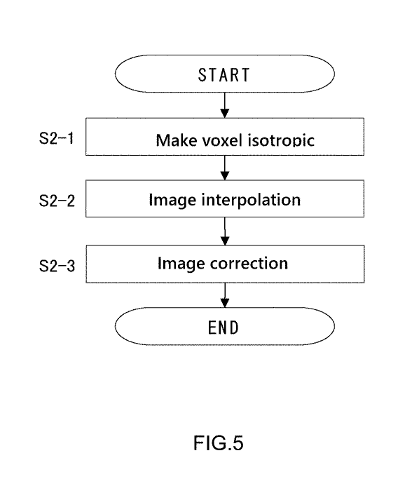

FIG. 5 is a flow diagram showing processing at the preprocessing unit 7.

The preprocessing unit 7 first calculates a correction value for making the size of a voxel constant in the XYZ-axis direction and then interpolates the voxel and makes it isotropic based on the correction value (S2-1). In this embodiment, interpolation is performed in the Z-axis direction (body axis direction), but it may be performed, without limitation, in another axis direction and make it isotropic as well. Next, image correction processing is performed for doubling the resolution of an image in which a voxel has been made isotropic (S2-2). Next, filter processing is performed in order to lower the image device dependence, the imaging condition dependence and the manufacturer dependence (S2-3). This image correction processing is performed for automatic deboning in the case of CTA and blood-flow dependence in the case of MRA.

### Shape-Model Generation Unit (S3)

Next, the shape-model generation unit 8 constructs a blood vessel model based on the preprocessed medical image.

In the shape model construction, regions are split by extracting voxels that satisfy fixed conditions for a medical image, and thereby a blood vessel region is extracted. The fixed conditions are generally defined by absolute values of luminance values (threshold method) and gradients of luminance values (gradient method). However, there are some problems that cannot be solved by these conventional methods. By way of example, the threshold method is a method for binarizing an image against one threshold level, but since luminance values are not constant depending on the sites and sizes of blood vessels, blood vessels that are included in a region to be examined cannot be evaluated by the same standard. More specifically, by the standard of a thick blood vessel, a thin blood vessel will be underestimated, while by the standard of a thin blood vessel, a thick blood vessel will be overestimated. Furthermore, the luminance value of a filmed image changes by imaging conditions such as the concentration of a contrast medium, for example, and in this respect, the threshold method that specifies blood vessels only by luminance values is problematic when evaluating blood vessels by the same standard. On the other hand, while a large number of methodologies have been proposed for the gradient method, the problem is that it has seed point dependence. In other words, it has starting point dependence in which, at the time of searching region by setting a starting points, results might be different if the search is started from a different starting point. Accordingly, the problem of the gradient method is also that blood vessels cannot be evaluated by the same standard. In order to solve these problems, the present inventors conducted experimental study to find a proper method for constructing a blood-vessel-shape model and found that a construction method in which the center line of a blood vessel is first coarsely extracted and then the blood vessel is precisely extracted, that is, a multi-stage construction method would be effective.

In other words, the shape-model generation unit 8 in this embodiment comprises a coarse extraction unit 12 and a precise extraction unit 13 and constructs a blood-vessel-shape model by a multi-stage construction method. That is, a blood vessel shape is precisely extracted after specifying the shape and type (e.g., the size of a blood vessel and aneurysm) of each blood vessel site in a region to be examined by a multi-stage construction method rather than methods for splitting regions by a single stage construction method such as the threshold method and the gradient method.

A description of specific processing is given below.

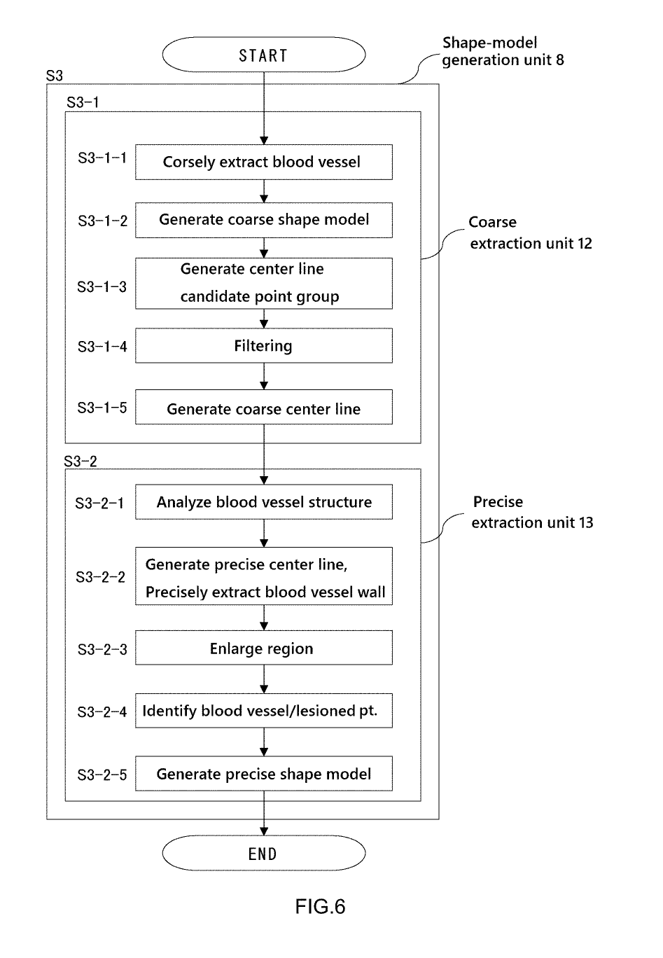

At the shape-model generation unit 8, as shown in FIG. 6, the coarse extraction unit 12 first coarsely extracts a blood vessel shape from a filmed image to generate a coarse center line (S3-1), and then the precise extraction unit 13 constructs a blood-vessel-shape model (S3-2) by performing precise extraction based on the coarsely extracted coarse center line.

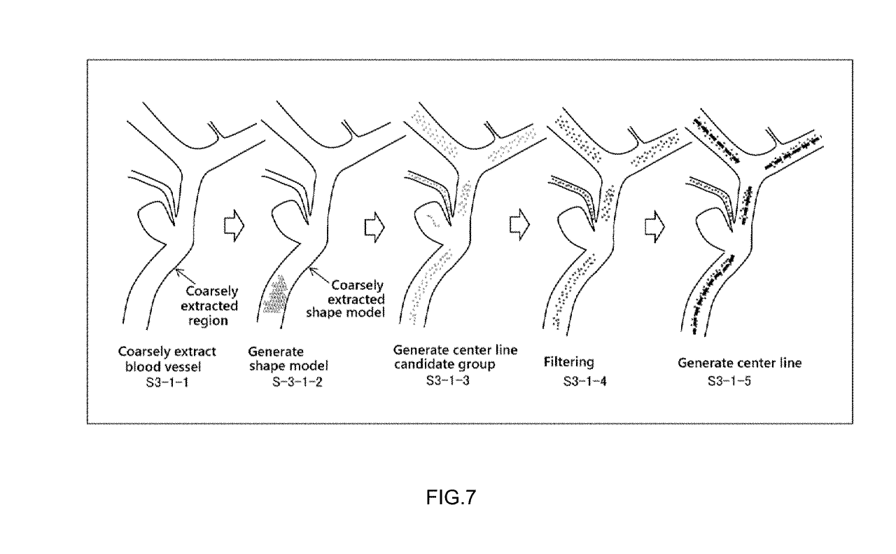

FIG. 7 is a view explaining processing at the coarse extraction unit 12. More specifically, the coarse extraction unit 12 first performs coarse extraction for a blood vessel using a conventional method such as the threshold method and the gradient method (S3-1-1). Next, the curved face of the blood vessel is formed by Marching cubes or the like (S3-1-2). At this stage, the blood vessel is constituted of minute triangular elements. Next, a center line candidate point group is generated by computation (S3-1-3). In this embodiment, the center line candidate point is a middle point of the points obtained by forming a line segment in the orthogonal direction within a blood vessel from the center of one triangular element up to the opposite side faces. Next, filtering processing is performed based on the abovementioned center line candidate point group and line segments (S3-1-4). Since each of minute triangles is controlled to have substantially the same size, the density of center line candidate point groups is proportional to the number of surrounding minute triangles. In other words, the number of point groups increases as the diameter of a blood vessel is large, while on the contrary the diameter of a blood vessel decreases when the density of point groups is small. At places such as aneurysms and branched places where center lines cannot mathematically be defined, the density of center line candidate point groups significantly declines. Accordingly, in order to construct a center line with fixed precision, filtering processing is performed in order to set a threshold level for the density of center line candidate point groups. Furthermore, while an aneurysm has a center line candidate point group inside, filtering processing may be performed for this portion using the line segment length of the center line in addition to the density of the center line. This is because a blood vessel shape used for blood-flow simulation needs to have at least a certain fixed length. Next, a center line is generated (S3-1-5). While the center line can be generated by various methods, it is calculated by interpolation such as B-spline in this embodiment. The center line generated by the coarse extraction unit 12 is referred to as a coarse center line hereinafter. Subsequently, the precise extraction unit 13 performs precise extraction based on this coarsely extracted coarse center line.

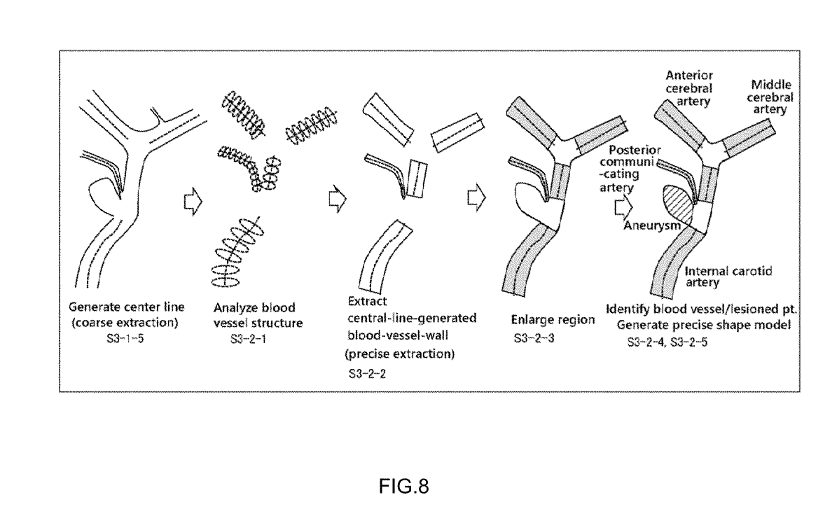

FIG. 8 is a view explaining processing at the precise extraction unit 13. The precise extraction unit 13 first performs blood vessel structure analysis for specifying an intravascular region based on a coarse center line generated by coarse extraction (S3-2-1). This blood vessel structure analysis is performed by executing intervascular/extravascular determination only for the region where the coarse center line has been formed. In this intervascular/extravascular determination, a perpendicular plane is formed from each point on the coarse center line, a luminance gradient is extracted on the perpendicular plane, and intravascular regions are determined up to the maximum value thereof. In this manner, in the present invention, a coarse center line is generated, and an intravascular region is determined using a perpendicular plane that passes through each point of the coarse center line, and thereby the seed point dependence that is difficult to be overcome by the conventional gradient method can be solved. Next, a blood vessel wall is precisely extracted based on the abovementioned determination, and a center line is regenerated for this precisely extracted blood vessel wall (S3-2-2). Next, the intravascular/extravascular determination is performed by a region expanding method for sites having no center line regenerated such as aneurysms and branched regions (S3-2-3). Finally, the blood vessel and lesioned parts are identified based on the anatomical position and orientation of the blood vessel and then labelling is performed (S3-2-4) in order to generate a precise shape model (S3-2-5). At A-3-2-4, vascular lesions such as cerebral aneurysms are identified by extracting relevant sites by calculating/analyzing topological changes in the blood vessel shape.

### Shape-Model-Quality Determination Unit (S4)

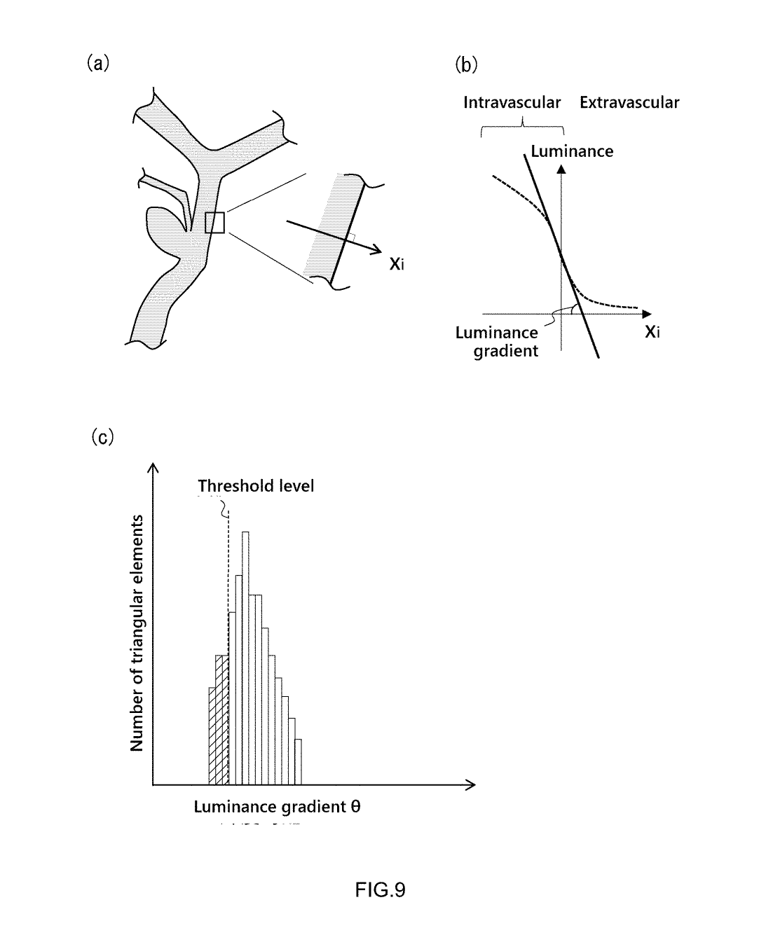

Next, the shape-model-quality determination unit 9 calculates a score showing the shape reproduction degree of the blood-vessel-shape model generated above based on the model and determines the quality of the blood-vessel-shape model based on the score (S4-1). Although the method for quantifying the quality of the blood-vessel-shape model is not only one, the “shape reproducibility of the blood vessel wall” is evaluated using information about a medical image used in the construction of a shape model in this embodiment. More specifically, a luminance gradient of the blood-vessel-shape model in the vicinity of the blood vessel wall is calculated based on luminance information about the medical image. In this embodiment, as shown in FIG. 9 (A), a line segment Xi (B) is formed in the orthogonal direction of the blood vessel surface from the center of a triangular element of the blood-vessel-shape model, and luminance gradients are calculated along the line segment. FIG. 9 (B) shows a graph in which the horizontal axis is Xi and the vertical axis shows luminance values. As shown in the same drawing, luminance values decline toward extravascular regions from intravascular regions in the vicinity of the blood vessel wall. The intravascular/extravascular contrast is clearer where a sudden decline occurs. The shape-model-quality determination unit 9 calculates the abovementioned luminance gradient for all the triangular elements on the surface of the blood-vessel-shape model. FIG. 9 (C) shows a histogram of the luminance gradient for each triangular element on the surface of the blood-vessel-shape model.

As shown in FIG. 9 (C) with an inclined line, the shape-model-quality determination unit 9 determines a luminance gradient equal to a threshold level or below as low quality. Subsequently, the shape-model-quality determination unit 9 calculates the percentage of those equal to the threshold level or below compared to the whole as a score showing the degree of reproduction and determines overall quality (Grade A, B, C).

In another embodiment, the shape-model-quality determination unit 9 may evaluate the overall quality of a blood-vessel-shape model by paying attention to the shape of a constructed shape model and calculating the irregularity degree of a blood vessel wall as a score showing the degree of reproduction. In this embodiment, the quality of the model is low as the irregularity is large, while the quality of the model is high as the irregularity is small.

In another embodiment, further processing may be performed for detecting and identifying the presence or absence of adhesions in the constructed shape model. Furthermore, the degree of adhesion may be quantified, and information about the degree of adhesion may be included in the condition of determining the overall quality of the shape model. By way of example, the ratio of adhering regions to the entire shape model may be calculated and included in the condition of determining the overall quality of the shape model. Alternatively, the overall quality of the blood-vessel-shape model may be evaluated by combining scores relating to the abovementioned luminance gradient, degree of irregularity and/or degree of adhesion.

Subsequently, the shape-model-quality determination unit 9 transmits the shape model and the quality determination result to the next step. In this embodiment, any shape model determined as low quality (e.g., Grade C) must be rejected (S4-2). In this case, a message to that effect, the quality determination result, scores, etc., for example, may be informed to a user by outputting them by the output unit 10 as described below. Alternatively, even when it is determined as low quality, a message showing the quality determination result and indicating the evaluation of low quality may be outputted, so that a user can confirm it, instead of automatically deleting the image.

### Output Unit (S5)

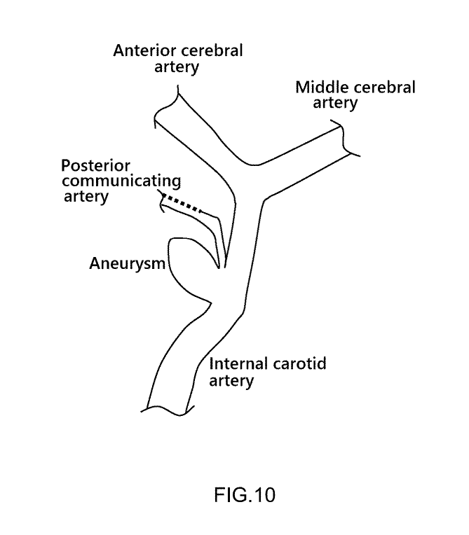

The output unit 10 outputs information calculated by the shape-model-quality determination unit 9 (e.g., luminance gradients, histograms thereof, scores), the quality evaluation result determined by the shape-model-quality determination unit 9 and the precise blood-vessel-shape model, etc. By way of example, places of low quality may be outputted and displayed on a three-dimensional blood-vessel-shape model or displayed in characters by associating them with blood vessels (labelling). FIG. 10 shows a relevant place that was found in the posterior communicating artery.

The configuration of each part of the device in the present invention is not limited to the illustrated configurational examples but can be modified in various manners as long as those modifications can substantially achieve similar actions.

By way of example, the configuration of a device according to the present invention and processing is described in the abovementioned embodiment as shown in FIG. 8, but the present invention is not limited to this example; it may be applied to other vascular sites such as the cerebral artery, the carotid artery, the coronary artery and the aorta, for example. Furthermore, it can be applied to vascular regions affected by other vascular lesions such as sclerosis and stenosis of blood vessels. Furthermore, the identification and extraction of vascular lesions are performed by calculating and analyzing topological changes in blood vessel shapes in the abovementioned embodiment, but the present invention is not limited to this example; other methods can also be used as long as those methods make it possible to precisely extract vascular lesioned parts.

Furthermore, by way of example, the overall quality of a shape model is determined by three stages, that is, Grade A, B and C in the abovementioned embodiment, but the present invention is not limited to this example; scores (numerical values) showing the degree of reproduction may be outputted as the overall result of quality determination, for example. Furthermore, cases in which information about luminance gradients, the degree of irregularity and adhesions is used are described in the abovementioned embodiment as a method for calculating scores showing the degree of reproduction, but the present invention is not limited to this example; other pieces of information may also be used for calculating scores in order to evaluate the shape of a blood-vessel-shape model for performing blood-flow analysis. Furthermore, scores (numerical values) showing the overall quality can be calculated based on a plurality of scores calculated by using multiple pieces of information. In this case, each score may be weighed, so that scores of the evaluation items that particularly tend to have an influence on the precision of blood-flow analysis can be reflected in scores showing the overall quality. Furthermore, the quality evaluation result may not necessarily be shown in the form of scores.

Furthermore, the device described in the abovementioned embodiment is provided with an output unit, but the present invention is not limited to this example; the abovementioned quality determination result and/or blood-vessel-shape model may be transmitted to other devices including other personal computers, laptop computers, smartphones and tablet computers with wires or wirelessly to output and display them.

Furthermore, in the device according to the present invention, a series of processing ranging from an image input to a shape model to an output of quality determination results can be performed totally automatically, but the present invention is not limited to this example. Furthermore, the device according to the present invention may be added with other processing suitable for constructing a precise blood-vessel-shape model in addition to processing at each device unit as explained in the abovementioned embodiment. Furthermore, it should be understood that the blood-vessel-shape construction device, method therefore and computer program according to the present invention can be applied to a wide variety of applications, as long as it can substantially achieve similar actions.

1. A device for constructing a blood-vessel-shape model in order to perform blood-flow analysis using computational fluid dynamics, the device comprising:
an input unit which inputs a medical image;
a shape-model generation unit which constructs a blood-vessel-shape model based on the medical image;
a shape-model-quality evaluation unit which evaluates shape reproduction degree of the blood-vessel-shape model to determine quality of the blood-vessel-shape model; and
an output unit which outputs a determination result and the blood-vessel-shape model.

2. The device according to claim 1, wherein:
the medical image comprises luminance information;
the shape-model-quality evaluation unit, using the luminance information of the medical image, calculates a luminance gradient in a direction perpendicular to a blood vessel wall in a vicinity of a blood vessel wall of the blood-vessel-shape model to determine the quality of the blood-vessel-shape model based on the luminance gradient; and
when the luminance gradient of the blood-vessel-shape model has a lower region than a prescribed value, the shape-model-quality evaluation unit determines the region as a low quality region.

3. The device according to claim 2, wherein the output unit further outputs and displays the low quality region on the blood-vessel-shape model.

4. The device according to claim 2, wherein the shape-model-quality evaluation unit calculates the luminance gradient for each unit region of the blood-vessel-shape model to determine a region having the luminance gradient of a threshold level or lower as a low quality region, also calculates a ratio of the low quality region to an entire surface of the blood-vessel-shape model, and outputs a score based on the ratio of the low quality region as the determination result.

5. The device according to claim 1, further comprising an image quality determination unit which acquires a kind information of the medical image to determine the quality of the medical image by collating the kind information with a quality determination table.

6. The device according to claim 5, wherein when the medical image does not satisfy a prescribed quality level, the image quality determination unit rejects the image, thereby preventing the blood-vessel-shape model from being generated.

7. The device according to claim 5, wherein the quality determination table comprises at least one of imaging device information, imaging condition information and manufacturer information.

8. The device according to claim 1, wherein the shape-model generation unit comprises: a first extraction unit which extracts a blood vessel region from the medical image and generates a blood vessel center line in at least one portion of the blood vessel region; and
a second extraction unit which performs intervascular/extravascular determination for the blood vessel site in which the blood vessel center line has been generated, based on the blood vessel center line and the medical image, and
also performs intervascular/extravascular determination for the blood vessel site in which no blood vessel center line has been generated, based on the medical image, thereby forming a precise blood-vessel-shape model.

9. The device according to claim 8, wherein the first extraction unit calculates a center line candidate point group of the blood vessel and generates the blood vessel center line based on the center line candidate point group.

10. The device according to claim 9, wherein the first extraction unit calculates the density of the center line candidate point group and a segment length of the blood vessel center line generated by the first extraction unit to determine size and shape of the blood vessel based on the density and the segment length.

11. The device according to claim 8, wherein the second extraction unit performs blood vessel structure analysis based on the blood vessel center line generated by the first extraction unit so that a second precise blood vessel center line and blood vessel wall are generated.

12. The device according to claim 11, wherein the blood vessel structure analysis is performed for a region within an orthogonal cross-section that passes through each point on the blood vessel center line generated by the first extraction unit.

13-24. (canceled)

25. A method executed by a computer in order to construct a blood-vessel shape model for performing blood-flow analysis using computational fluid dynamics, the method comprising:
a reading step for reading a medical image using a computer;
a shape-model generation step for constructing a blood-vessel-shape model using a computer based on the medical image;
a shape-model-quality evaluation step for evaluating shape reproduction degree of the blood-vessel-shape model using a computer in order to determine quality of the blood-vessel-shape model; and
an output step for outputting a determination result and the blood-vessel-shape using a computer.

26. The method according to claim 25, wherein:
the medical image comprises luminance information;
the shape-model-quality evaluation step, using the luminance information of the medical image, has a computer calculate a luminance gradient in a direction perpendicular to a blood vessel wall in a vicinity of a blood vessel wall of the blood-vessel-shape model to determine the quality of the blood-vessel-shape model based on the luminance gradient; and
when the luminance gradient of the blood-vessel-shape model has a lower region than a prescribed value, the shape-model-quality evaluation step determines the region as a low quality region.

27. The method according to claim 26, wherein the output step further has a computer output and display the region of low quality on the blood-vessel-shape model.

28. The method according to claim 26, wherein the shape-model-quality evaluation step calculates a luminance gradient for each unit region of the blood-vessel-shape model to determine a region having the luminance gradient of a threshold level or lower as a low quality region, also calculates a ratio of the low-quality region to an entire surface of the blood-vessel-shape model, and outputs a score based on the ratio of the low quality region as the determination result.

29. The method according to claim 25, further comprising an image quality determination unit which has a computer acquire the kind information of the medical image to determine the quality of the medical image by checking this kind information against a quality determination table.

30. The method according to claim 29, wherein when the medical image does not satisfy prescribed quality, the image quality determination step rejects the image, thereby preventing the blood-vessel-shape model from being generated.

31. The method according to claim 29, wherein the quality determination table comprises at least one piece of information from among an imaging device, an imaging condition and a manufacturer.

32. The method according to claim 25, wherein the shape-model generation step comprises: a first extraction unit which has a computer extract a blood vessel region from the medical image and generates a blood vessel center line in at least one portion of the blood vessel region; and
a second extraction step which has a computer perform intervascular/extravascular determination for the blood vessel site in which the blood vessel center line has been generated based on the blood vessel center line and the medical image and also performs intervascular/extravascular determination for the blood vessel site in which no blood vessel center line has been generated based on the medical image, thereby forming a precise blood-vessel-shape model.

33. The method according to claim 32, wherein the first extraction step calculates a center line candidate point group of the blood vessel and generates the blood vessel center line based on the center line candidate point group.

34. The method according to claim 33, wherein the first extraction step calculates the density of the center line candidate point group and the segment length of the blood vessel center line to determine the size and shape of the blood vessel based on the density and the segment length.

35. The method according to claim 32, wherein the second extraction step performs blood vessel structure analysis based on the blood vessel center line generated by the first extraction step to generate a second precise blood vessel center line and blood vessel wall.

36. The method according to claim 35, wherein the blood vessel structure analysis is performed for a region within an orthogonal cross-section that passes through each point on the blood vessel center line generated by the first extraction unit.
